(19) United States
(12) Patent Application Publication
(10) Pub. No.: US 2003/0214887 A1
(43) Pub. Date: Nov. 20, 2003

(54) Signal processing circuit digitizing input analog signal together with included chattering component

(76) Inventor: Akira Mashimo, Tokorozawa-Shi (JP)

Correspondence Address: ANDERSON KILL & OLICK, P.C., 1251 Avenue of the Americas, New York, NY, 10020, US

(21) Appl. No.: 10/405,332

(22) Filed: Apr. 1, 2003

(30) Foreign Application Priority Data
May 20, 2002 (JP) 2002-144478

(51) Int. Cl. G11B 7/00

(52) U.S. Cl. 369/47.17; 369/53.33

(57) ABSTRACT

An input analog signal is digitized according to a level thereof by a digitizing circuit. A chattering component is removed from the digitized signal by a chattering removing circuit. A signal processing is performed according to the signal from which the chattering component is removed by the chattering removing circuit. In this course, the input analog signal is digitized together with the chattering component included therein by the digitizing circuit.

### BACKGROUND OF THE INVENTION

1. Field of the Invention

The present invention generally relates to a signal processing circuit, and more particularly, to a signal processing circuit processing a digitized wobble signal.

2. Description of the Related Art

Conventionally, a wobble is formed on a recording optical disk, such as a CD or a DVD, in which a track for recording/reproducing information wobbles in radial directions. An optical disk device comprises an optical head that faces a surface of the disk upon the disk being mounted on the optical disk device. The optical head projects a laser light on the disk so as to record information on the disk, and also receives a reflected light from the disk so as to output a reproduction signal corresponding to information recorded on the disk. Information reproduced by the optical head includes a signal originating from the wobble formed on the disk (hereinafter referred to as a wobble signal). The optical disk device extracts the wobble signal from the information reproduced by the optical head, and according to this wobble signal, performs an obtainment of address information representing a disk position, a drive control of a spindle motor to revolve the disk, or a generation of a reference clock, and so forth.

Thus, in order to cause the optical disk device to function appropriately, a wobble signal that accords appropriately to the wobble formed on the optical disk needs to be generated from the wobble. That is, if a wobble signal is not appropriately and surely reproduced according to the wobble of the disk, it may happen that a recording to the disk is interrupted, and further that the recording becomes unable to resume. Accordingly, to avoid these inconveniences, it is important to monitor a quality of the wobble signal generated from the wobble of the optical disk.

The quality of the wobble signal is found aggravated when a detection error of the address information and so forth included in the wobble signal occurs. Accordingly, it is possible to judge the quality of the wobble signal according to whether or not the detection error of the address information exists.

However, the detection error of the address information based on the wobble signal does not occur until the quality of the wobble signal becomes aggravated considerably. Accordingly, when the detection error of the address information is detected, it may already happen that a recording to the disk is interrupted, and further that the recording becomes unable to resume, due to the aggravation of the quality of the wobble signal. Therefore, in consideration of this point, it is not appropriate to judge the quality of the wobble signal according to whether or not the detection error of the address information occurs.

In addition, normally, in a conventional signal processing circuit included in the optical disk device of this type, the wobble signal is processed after being digitized. In this course, a feedback is provided for a comparator of a digitizing circuit so as to provide a hysteresis, thereby removing a chattering included in an analog signal. However, providing the digitizing circuit with the hysteresis causes a problem that a C/N after the digitization is aggravated due to level changes in the wobble signal or influences of noises, causing a failure to perform a stable wobble signal evaluation or to perform an accurate signal detection.

Besides, because of the hysteresis provided for the digitizing circuit, a timing of edges of the digitized signal becomes inaccurate. This inaccuracy in the timing of the edges causes a failure to perform an accurate signal detection.

### SUMMARY OF THE INVENTION

It is a general object of the present invention to provide an improved and useful signal processing circuit in which the above-mentioned problems are eliminated.

A more specific object of the present invention is to provide a signal processing circuit capable of performing an accurate and stable signal processing.

In order to achieve the above-mentioned objects, there is provided according to one aspect of the present invention a signal processing circuit performing a signal processing according to a signal rid of a chattering component, the circuit comprising a digitizing circuit digitizing an input analog signal together with the chattering component included therein according to a level of the input analog signal, and a chattering removing circuit removing the chattering component from the signal digitized by the digitizing circuit.

Additionally, in the signal processing circuit according to the present invention, the digitizing circuit includes an integration circuit outputting an average level of the input analog signal, and an open-loop comparator performing a comparison of the input analog signal with the average level so as to output a signal corresponding to a result of the comparison.

According to the present invention, the digitizing circuit digitizes the input analog signal together with the chattering component included therein, and the chattering component is removed by the chattering removing circuit from the signal digitized together with the chattering component included therein; accordingly, the wobble signal can be evaluated accurately and stably.

Additionally, according to the present invention, the digitizing circuit is provided with no hysteresis and so forth, and thus, a C/N after the digitization is not deteriorated; accordingly, an accurate and stable signal processing can be performed.

Other objects, features and advantages of the present invention will become more apparent from the following detailed description when read in conjunction with the accompanying drawings.

### BRIEF DESCRIPTION OF THE DRAWINGS

FIG. 1 is a block diagram of an optical disk, device including a signal processing circuit according to an embodiment of the present invention;

FIG. 2 is an illustration of a structure of an optical disk mounted on the optical disk device according to the present embodiment;

FIG. 3 is a block diagram of the signal processing circuit of the optical disk device according to the present embodiment;

FIG. 4 is a diagram showing a circuit configuration of a pulse signal generation circuit according to the present embodiment;

FIG. 5 is a diagram showing operational waveforms of the pulse signal generation circuit according to the present embodiment;

FIG. 6 is a diagram showing operational waveforms of the signal processing circuit according to the present embodiment;

FIG. 7 is a diagram used for explaining a method for judging a quality of a wobble signal according to the present embodiment;

FIG. 8 is a graph comparing a case where a quality of a wobble signal is judged by using the method according to the present embodiment with a case where a quality of a wobble signal is judged by using a method according to a comparative example; and

FIG. 9 is a block diagram showing a configuration of a variation of the pulse signal generation circuit.

### DETAILED DESCRIPTION OF THE PREFERRED EMBODIMENTS

A description will now be given, with reference to the drawings, of embodiments according to the present invention.

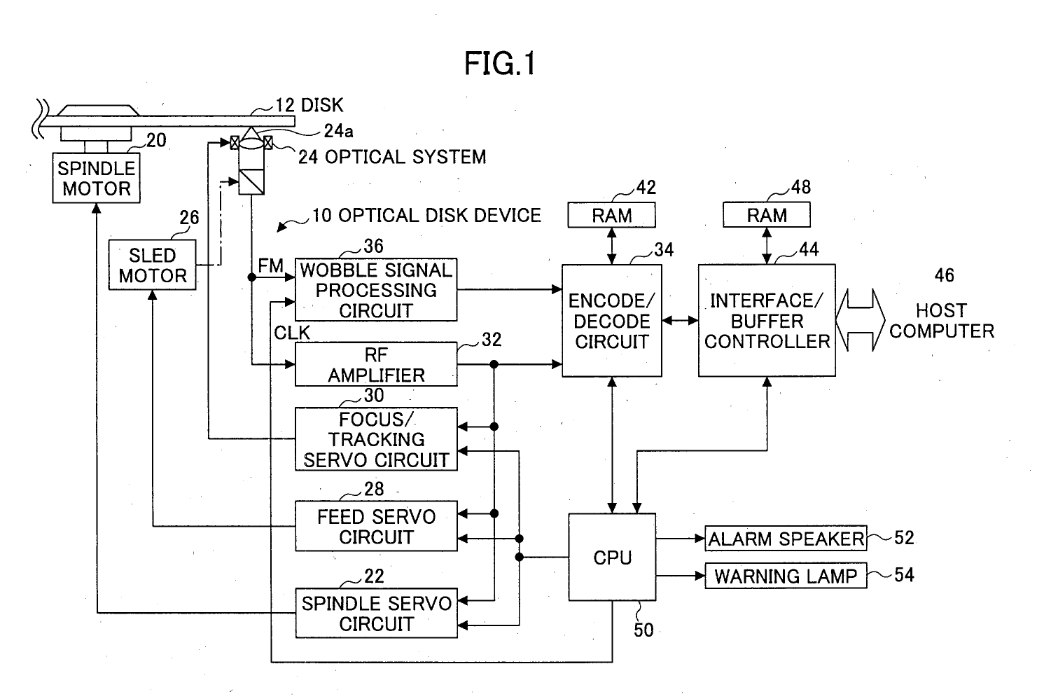

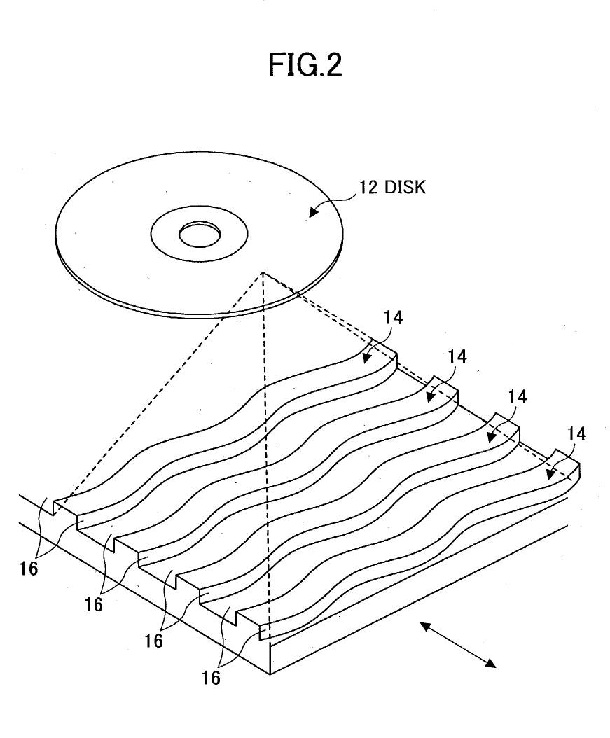

FIG. 1 is a block diagram of an optical disk device 10 according to an embodiment of the present invention. FIG. 2 is an illustration of a structure of an optical disk mounted on the optical disk device 10 according to the present embodiment.

In the present embodiment, the optical disk device 10 is, for example, a DVD-R/RW drive (a block diagram of a recording system is omitted). A DVD-R/RW disk (hereinafter simply referred to as a disk) 12 is mounted on the optical disk device 10 so that the optical disk device 10 records/reproduces information with respect to the disk 12. As shown in FIG. 2, the disk 12 mounted on the optical disk device 10 includes a groove 14 as a track on/from which information is recorded/reproduced. The groove 14 wobbles in radial directions of the disk 12 at a predetermined cycle. That is, a wobble 16 in a form of sine waves is formed on the disk 12.

As shown in FIG. 1, the optical disk device 10 comprises a spindle motor 20. The spindle motor 20 has a function of revolving the disk 12 mounted on the optical disk device 10. The spindle motor 20 is connected with a spindle servo circuit 22. The spindle servo circuit 22 performs a drive direction over the spindle motor 20 so that the disk 12 revolves at a predetermined revolving speed.

The optical disk device 10 also comprises an optical-system 24. The optical system 24 includes an optical head 24a positioned so as to face a surface of the disk 12 mounted on the optical disk device 10. The optical head 24a projects a laser light (a laser beam) on the disk 12 so as to record information on the disk 12, and also receives a reflected light from the disk 12 so as to output a reproduction signal corresponding to information recorded on the disk 12.

The optical disk device 10 also comprises a sled motor 26. The sled motor 26 has a function of moving a carriage composing the optical system 24 in the radial directions of the disk 12. The sled motor 26 is connected with a feed servo circuit 28. The feed servo circuit 28 performs a drive direction over the sled motor 26 so that the carriage of the optical system 24 is positioned at a predetermined diametrical position.

The optical system 24 includes a focus/tracking actuator (not shown in the figure) performing a focus/tracking control of the optical system 24. The focus/tracking actuator is connected with a focus/tracking servo circuit 30. The focus/tracking servo circuit 30 performs a drive direction over the actuator so that the optical system 24 is focused/tracked according to a predetermined rule. The sled motor 26 and the focus/tracking actuator are thus driven so that the location of the laser beam projected on the disk 12 by the optical system 24 is controlled.

The optical system 24 is connected with an RF amplifier 32. The reproduction signal output by the optical head 24a, the reproduction signal corresponding to information recorded on the disk 12, is supplied to the RF amplifier 32. The RF amplifier 32 amplifies the reproduction signal. The RF amplifier 32 is connected with an encode/decode circuit 34. A primary signal of the reproduction signal amplified by the RF amplifier 32 is supplied to the encode/decode circuit 34. The encode/decode circuit 34 extracts various servo signals from the signal supplied from the RF amplifier 32, and outputs the signals to each of the servo circuits. The encode/decode circuit 34 also performs processes, such as an encoding/decoding of ECC (Error Correcting Code) specific to the disk, and a detection of a header.

The optical system 24 is also connected with a wobble signal processing circuit 36. The reproduction signal output by the optical head 24a includes a signal in the form of sine waves originating from the wobble 16 formed on the disk 12 (hereinafter referred to as a wobble signal). The wobble signal processing circuit 36 extracts the wobble signal in the form of sine waves from the reproduction signal output by the optical head 24a, and processes the signal as described hereinafter in detail. The wobble signal processing circuit 36 is also connected with the above-described encode/decode circuit 34. The encode/decode circuit 34 demodulates the signal supplied from the wobble signal processing circuit 36, and extracts address information representing a track position on the disk 12 from the signal.

The encode/decode circuit 34 comprises a RAM 42. The RAM 42 is used as a working storage for the processes performed in the encode/decode circuit 34.

The encode/decode circuit 34 is connected with an interface/buffer controller 44. The interface/buffer controller 44 connects to a host computer 46. The interface/buffer controller 44 exchanges data with the host computer 46, and controls a data buffer. The interface/buffer controller 44 comprises a RAM 48. The RAM 48 is used as a working storage for the interface/buffer controller 44.

The encode/decode circuit 34 and the interface/buffer controller 44 are connected with a CPU 50. The CPU 50 controls the optical disk device 10 as a whole according to directions from the host computer 46, specifically, such as the controls by the spindle servo circuit 22, the feed servo circuit 28 and the focus/tracking servo circuit 30, as well as the control of the laser in the optical system 24. The CPU 50 is connected with an alarm speaker 52 and a warning lamp 54. The CPU 50 drives the alarm speaker 52 and the warning lamp 54 when an abnormality occurs with respect to the control of the optical disk device 10. According to directions from the CPU 50, the alarm speaker 52 and the warning lamp 54 perform an alarming/warning with respect to the abnormality of the optical disk device 10.

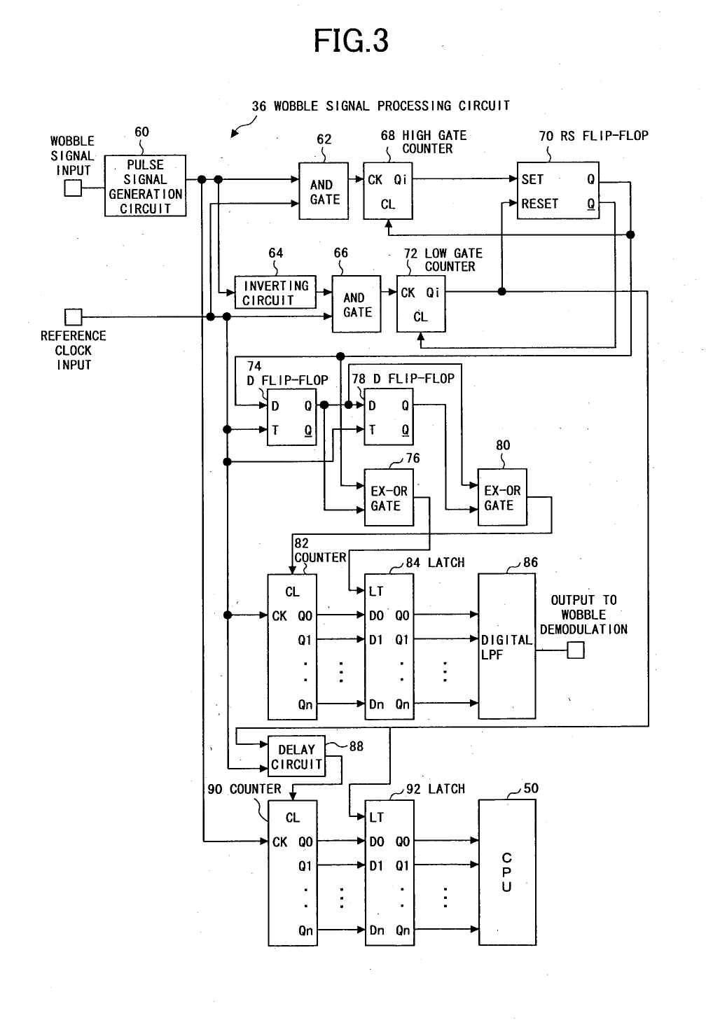

FIG. 3 is a block diagram of the wobble signal processing circuit 36 of the optical disk device 10.

The wobble signal processing circuit 36 comprises a pulse signal generation circuit 60. The frequency-modulated (FM) wobble signal is supplied from the optical head 24a of the optical system 24 to the pulse signal generation circuit 60.

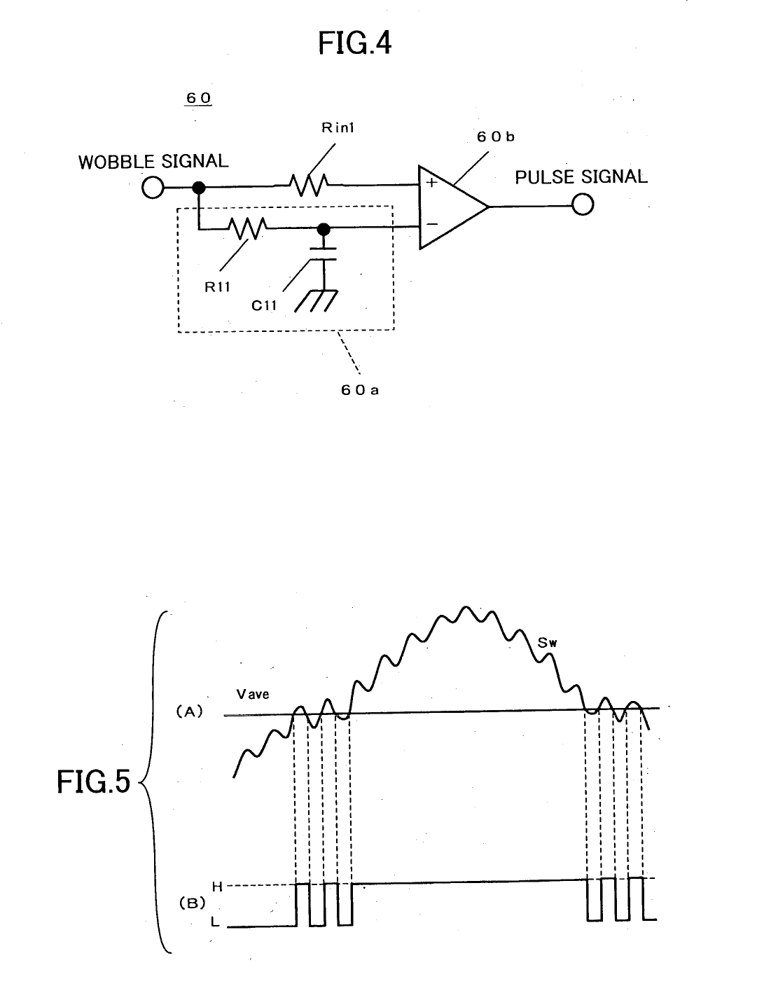

FIG. 4 is a diagram showing a circuit configuration of the pulse signal generation circuit 60. FIG. 5 is a diagram showing operational waveforms of the pulse signal generation circuit 60. FIG. 5-(A) indicates the wobble signal (Sw). FIG. 5-(B) indicates a signal digitized from the wobble signal.

The pulse signal generation circuit 60, which is equivalent to a digitizing circuit according to the present invention, comprises an input resistance Rin1, an integration circuit 60a and a comparator 60b. The pulse signal generation circuit 60 is supplied with the wobble signal Sw as shown in FIG. 5-(A).

The wobble signal Sw is supplied to a noninverting input terminal of the comparator 60b via the input resistance Rin1, and is also supplied to the integration circuit 60a.

The integration circuit 60a comprises a resistance R11 and a capacitor C11, and integrates the wobble signal so as to output a voltage signal Vave corresponding to an average level of the wobble signal as shown in FIG. 5-(A). The output voltage signal Vave of the integration circuit 60a is supplied to an inverting input terminal of the comparator 60b.

The comparator 60b is formed of an operational amplifier, and compares the wobble signal supplied to the noninverting input terminal with the output voltage signal supplied to the inverting input terminal. When the wobble signal supplied to the noninverting input terminal is larger than the output voltage signal supplied to the inverting input terminal, the comparator 60b brings an output signal (an FM pulse signal) thereof to a high level; when the wobble signal supplied to the noninverting input terminal is smaller than the output voltage signal supplied to the inverting input terminal, the comparator 60b brings the output signal to a low level. In this course, the comparator 60b is provided with no feedback, and thus with no hysteresis. Accordingly, the wobble signal Sw including a chattering component as shown in FIG. 5-(A) is digitized so that the chattering component is together digitized as shown in FIG. 5-(B).

According to the pulse signal generation circuit 60 of the present embodiment, the chattering component included in the input wobble signal (an input analog signal) is together digitized; accordingly, in subsequent circuits, processes can be performed based on the digitized signal including the chattering component so that the wobble signal can be evaluated accurately.

Additionally, according to the present embodiment, in the pulse signal generation circuit 60, no delay occurs in the digitized signal because of a hysteresis and so forth; accordingly, processes can be performed according to an accurate timing so that accurate process results can be obtained in subsequent circuits.

Besides, in the present embodiment, a circuit having a configuration composed of counters, flip-flops, gates and so forth as shown in FIG. 3, which demodulates the wobble signal and obtains an evaluation result thereof, is described as a signal processing circuit subsequent to the pulse signal generation circuit 60; however, a configuration of the subsequent circuit is not limited to the circuit configuration shown in FIG. 3, and another circuit is conceivable which measures a high-level or low-level period of the wobble signal digitized by the capacitor and so forth in the pulse signal generation circuit 60, and performs a demodulation and an evaluation of the wobble signal.

An output terminal of the pulse signal generation circuit 60 is connected to an AND gate 62, and is also connected to an AND gate 66 via an inverting circuit 64. A reference clock at a predetermined time interval is supplied from the CPU 50 to both the AND gates 62 and 66. When a wobble signal resulting from being converted into the FM pulse signal by the pulse signal generation circuit 60 is at the high level, the AND gate 62 passes the reference clock supplied from the CPU 50. An output terminal of the AND gate 62 is connected with a clock input terminal of a high gate counter 68. The reference clock passed through the AND gate 62 is supplied to the high gate counter 68. The high gate counter 68 has a function of counting the supplied reference clock. An output terminal of the high gate counter 68 is connected to a set terminal of an RS flip-flop 70. The high gate counter 68 supplies the set terminal of the RS flip-flop 70 with a value Qᵢ at an i-th digit (i-th representing an ordinal number) of a count value obtained by counting the reference clock.

The inverting circuit 64 inverts the wobble signal converted into the FM pulse signal by the pulse signal generation circuit 60, and supplies the inverted signal to the AND gate 66. When the signal supplied from the inverting circuit 64 is at a high level, in other words, when the wobble signal converted into the FM pulse signal by the pulse signal generation circuit 60 is at the low level, the AND gate 66 passes the reference clock supplied from the CPU 50. An output terminal of the AND gate 66 is connected with a clock input terminal of a low gate counter 72. The reference clock passed through the AND gate 66 is supplied to the low gate counter 72. The low gate counter 72 has a function of counting the supplied reference clock. An output terminal of the low gate counter 72 is connected to a reset terminal of the RS flip-flop 70. The low gate counter 72 supplies the reset terminal of the RS flip-flop 70 with a value Qᵢ at an i-th digit of a count value obtained by counting the reference clock.

Accordingly, when the value Qᵢ at the i-th digit of the high gate counter 68 rises, the RS flip-flop 70 sets a noninverted output Q (, i.e., to high level), and resets an inverted output inverter-Q (, i.e., to low level). When the value Qᵢ at the i-th digit of the low gate counter 72 rises, the RS flip-flop 70 resets the noninverted output Q, and sets the inverted output inverter-Q.

A noninverted output terminal Q of the RS flip-flop 70 is connected to a clear terminal of the high gate counter 68. The high gate counter 68 is cleared when the noninverted output Q of the RS flip-flop 70 is at the high level. An inverted output terminal inverter-Q of the RS flip-flop 70 is connected to a clear terminal of the low gate counter 72. The low gate counter 72 is cleared when the inverted output inverter-Q of the RS flip-flop 70 is at the high level.

The noninverted output terminal Q of the RS flip-flop 70 is also connected to a data terminal of a D flip-flop 74, and is connected to an EX-OR gate 76. The above-mentioned reference clock from the CPU 50 is supplied to a clock terminal of the D flip-flop 74. The D flip-flop 74 retains a level detected at the data terminal upon the reference clock rising, and outputs the level. An output terminal Q of the D flip-flop 74 is connected to a data terminal of a D flip-flop 78, is connected to the above-mentioned EX-OR gate 76, and is also connected to an EX-OR gate 80. The EX-OR gate 76 outputs an exclusive OR of the noninverted output Q of the RS flip-flop 70 and the output of the D flip-flop 74.

The above-mentioned reference clock from the CPU 50 is supplied to a clock terminal of the D flip-flop 78. The D flip-flop 78 retains a level detected at the data terminal upon the reference clock rising, and outputs the level. An output terminal Q of the D flip-flop 78 is connected to the above-mentioned EX-OR gate 80. The EX-OR gate 80 outputs an exclusive OR of the output of the D flip-flop 74 and the output of the D flip-flop 78.

An output terminal of the EX-OR gate 80 is connected to a clear terminal of a counter 82. The reference clock from the CPU 50 is supplied to the counter 82. The counter 82 counts the reference clock, and when the output of the EX-OR gate 80 is at high level, the counter 82 clears a count value. Output terminals of the counter 82 are connected to a latch 84. An output terminal of the above-mentioned EX-OR gate 76 is connected to a latch terminal of the latch 84. The latch 84 latches the count value supplied from the counter 82 when the output of the EX-OR gate 76 rises.

Output terminals of the latch 84 are connected with a digital LPF (Low Pass Filter) 86. The digital LPF 86 performs a low-pass process with respect to the count value, which is a digital value, supplied from the latch 84 so as to remove noises. Accordingly, the wobble signal processing circuit 36 converts the wobble signal originating from the wobble 16 formed on the disk 12 according to the address information, from the frequency-modulated signal in the form of sine waves, into a digital signal, and outputs the digital signal to the encode/decode circuit 34.

The output terminal of the low gate counter 72 is connected to an input terminal of a delay circuit 88. The reference clock from the CPU 50 is supplied to the delay circuit 88. When the output of the low gate counter 72 becomes high-level, the delay circuit 88 keeps an output thereof low-level until a next clock is supplied; when the next clock is supplied, the delay circuit 88 makes the output high-level; and when a clock after the next clock is supplied, the delay circuit 88 makes the output low-level. An output terminal of the delay circuit 88 is connected to a clear terminal-of a counter 90. The counter 90 is connected with the pulse signal generation circuit 60, and is supplied with the wobble signal digitally converted into the FM pulse signal. The counter 90 counts a number of times edges of the wobble signal rise from the low level to the high level, and when the output of the delay circuit 88 is at the high level, the counter 90 clears a count value thereof.

Output terminals of the counter 90 are connected to input terminals of a latch 92. The above-mentioned output terminal of the low gate counter 72 is also connected to a latch terminal of the latch 92. The latch 92 latches the count value supplied from the counter 90 when the output of the low gate counter 72 rises. Output terminals of the latch 92 are connected with the CPU 50. The CPU 50 detects the number of the times the edges of the wobble signal converted into the FM pulse signal rise from the low level to the high level according to the count value latched by the latch 92.

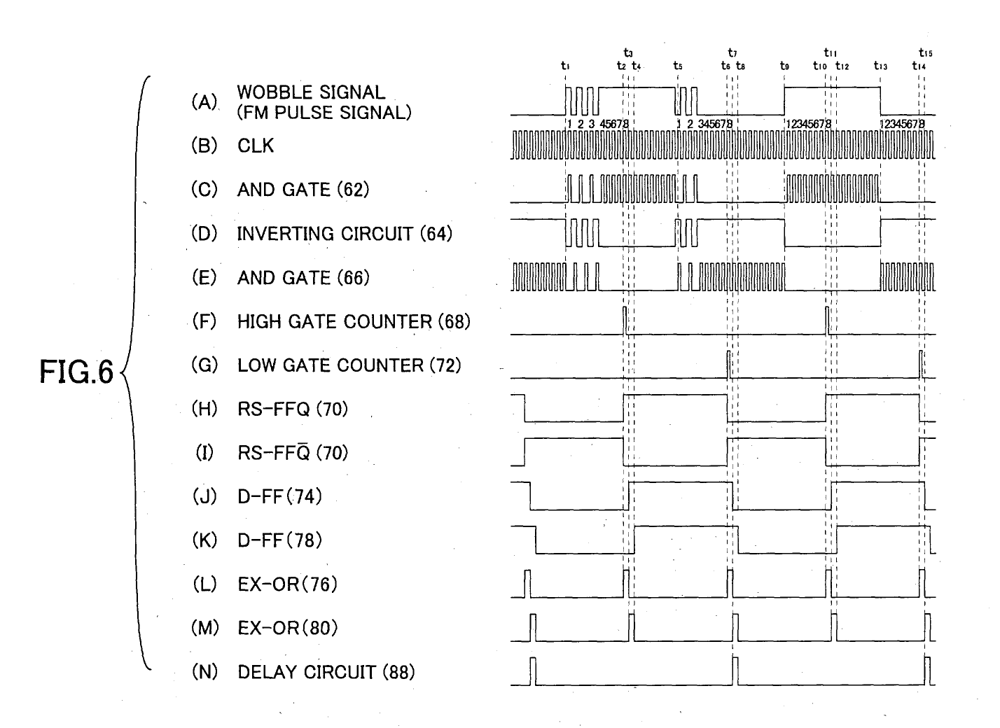

Next, a description will be given, with reference to FIG. 6, of an operation of the wobble signal processing circuit 36 shown in FIG. 3.

FIG. 6 is a diagram showing operational waveforms of the wobble signal processing circuit according to the present embodiment. FIG. 6-(A) shows an output waveform of the pulse signal generation circuit 60. FIG. 6-(B) shows the reference clock. FIG. 6-(C) shows an output waveform of the AND gate 62. FIG. 6-(D) shows an output waveform of the inverting circuit 64. FIG. 6-(E) shows an output waveform of the AND gate 66. FIG. 6-(F) shows an output waveform of the high gate counter 68. FIG. 6-(G) shows an output waveform of the low gate counter 72. FIG. 6-(H) shows a noninverted output waveform of the RS flip-flop 70. FIG. 6-(I) shows an-inverted output waveform of the RS flip-flop 70. FIG. 6-(J) shows an output waveform of the D flip-flop 74. FIG. 6-(K) shows an output waveform of the D flip-flop 78. FIG. 6-(L) shows an output waveform of the EX-OR gate 76. FIG. 6-(M) shows an output waveform of the EX-OR gate 80. FIG. 6-(N) shows an output waveform of the delay circuit 88.

Under a condition where the wobble signal in the form of pulses generated by the pulse signal generation circuit 60 is kept at low level (prior to time t1 (or time t9)), the noninverted output Q of the RS flip-flop 70 is kept at low level, and the inverted output inverter-Q thereof is kept at high level. Therefore, the low gate counter 72 is in a cleared state, as shown in FIG. 6-(G). When the wobble signal in the form of pulses changes from the above-mentioned condition to high level at time t1 as shown in FIG. 6-(A), the AND gate 62 passes the reference clock only during the period in which the wobble signal is at high level, as shown in FIG. 6-(C), so that the high gate counter 68 starts counting the clock. Besides, when the wobble signal in the form of pulses changes from high level to low level, the AND gate 62 does not pass the reference clock, whereby the high gate counter 68 interrupts the counting of the clock.

Assuming that the high gate counter 68 supplies the set terminal of the RS flip-flop 70 with a value Q₃ at a 3rd digit, for example, the high gate counter 68 supplies the set terminal of the RS flip-flop 70 with a low-level signal until the high gate counter 68 counts the clock to eight. Then, upon counting the clock to eight at time t2 (or time t10), the high gate counter 68 supplies the set terminal of the RS flip-flop 70 with a high-level signal, as shown in FIG. 6-(F). When the set terminal is supplied with the high-level signal, the noninverted output Q of the RS flip-flop 70 is inverted to high level, as shown in FIG. 6-(H), and the inverted output inverter-Q thereof is inverted to low level, as shown in FIG. 6-(I). When the noninverted output Q of the RS flip-flop 70 becomes high level, the high gate counter 68 is brought into a cleared state. When the inverted output inverter-Q of the RS flip-flop 70 becomes low level, the cleared state of the low gate counter 72 is cancelled.

Additionally, when the noninverted output Q of the RS flip-flop 70 is inverted to high level, the output of the D flip-flop 74 continues to be low level until a next clock is supplied. When this condition is fulfilled, the two inputs of the EX-OR gate 76 are high-level and low-level, respectively, so that the output of the EX-OR gate 76 is inverted from low level to high level, as shown in FIG. 6-(L). When the output of the EX-OR gate 76 is inverted to high level, the latch 84 latches the output of the counter 82 upon an up edge of the output of the EX-OR gate 76.

Thereafter, when the next clock is supplied at time t3 (or time t11), the output of the D flip-flop 74 is inverted to high level, as shown in FIG. 6-(J), so that both the two inputs of the EX-OR gate 76 become high-level. In this case, the output of the EX-OR gate 76 is inverted from high level to low level. Additionally, when the output of the D flip-flop 74 is inverted to high level, the output of the D flip-flop 78 continues to be low level until a next clock is supplied. When this condition is fulfilled, the two inputs of the EX-OR gate 80 are high-level and low-level, respectively, so that the output of the EX-OR gate 80 is inverted from low level to high level, as shown in FIG. 6-(M). When the output of the EX-OR gate 80 is inverted to high level, the count value of the counter 82 is cleared. Thus, the count value of the counter 82 is cleared immediately after being latched by the latch 84.

Thereafter, when the next clock is supplied at time t4 (or time t12), the output of the D flip-flop 78 is inverted to high level, as shown in FIG. 6-(K), so that both the two inputs of the EX-OR gate 80 become high-level. In this case, the output of the EX-OR gate 80 is inverted from high level to low level. When the output of the EX-OR gate 80 becomes low level, the cleared state of the counter 82 is cancelled.

Subsequently, when the wobble signal in the form of pulses changes from high level to low level at time t5 (or time t13), the AND gate 66 passes the reference clock only during the period in which the wobble signal is at low level, as shown in FIG. 6-(E), so that the low gate counter 72 performs a counting of the clock. Besides, when the wobble signal in the form of pulses changes from low level to high level, the AND gate 66 does not pass the reference clock, whereby the low gate counter 72 interrupts the counting of the clock.

Assuming that the low gate counter 72 supplies the reset terminal of the RS flip-flop 70 with a value Q₃ at a 3rd digit, for example, the output of the low gate counter 72 is kept at low level until the low gate counter 72 counts the clock to eight. Then, when the clock is counted to eight at time t6 (or time t14), the output of the low gate counter 72 is inverted to high level, as shown in FIG. 6-(G). In this case, the reset terminal of the RS flip-flop 70, the latch terminal of the latch 92, and the delay circuit 88 are supplied with a high-level signal.

When the reset terminal of the RS flip-flop 70 is supplied with the high-level signal, the noninverted output Q of the RS flip-flop 70 is inverted to low level so as to be reset, and the inverted output inverter-Q thereof is inverted to high level. When the noninverted output Q of the RS flip-flop 70 is reset, the cleared state of the high gate counter 68 is cancelled. When the inverted output inverter-Q of the RS flip-flop 70 becomes high level, the low gate counter 72 is brought into a cleared state. When the latch terminal of the latch 92 is supplied with the high-level signal, the latch 92 latches the output of the counter 90 upon an up edge of the high-level signal.

Additionally, when the noninverted output Q of the RS flip-flop 70 is inverted to low level, the output of the D flip-flop 74 continues to be high level until a next clock is supplied. Thereby, the two inputs of the EX-OR gate 76 become low-level and high-level, respectively, so that the output of the EX-OR gate 76 is inverted from low level to high level. In this case, the latch 84 latches the count value of the counter 82 at that point, upon an up edge of the output of the EX-OR gate 76.

Thereafter, when the next clock is supplied at time t7 (or time t15), the output of the D flip-flop 74 is inverted to low level so that both the two inputs of the EX-OR gate 76 become low-level. Thereby, the output of the EX-OR gate 76 is inverted from high level to low level. Additionally, when the output of the D flip-flop 74 is inverted to low level, the output of the D flip-flop 78 continues to be high level until a next clock is supplied. Thereby, the two inputs of the EX-OR gate 80 become low-level and high-level, respectively, so that the output of the EX-OR gate 80 is inverted from low level to high level. In this case, the count value of the counter 82 is cleared.

In addition, when the clock is supplied at time t7 (or time t15), the output of the delay circuit 88 is inverted from low level to high level. In this case, the count value of the counter 90 is cleared. Thus, the count value of the counter 90 is cleared immediately after being latched by the latch 92.

Thereafter, when the clock is supplied at time t8, the output of the D flip-flop 78 is inverted to low level so that both the two inputs of the EX-OR gate 80 become low-level. Thereby, the output of the EX-OR gate 80 is inverted from high level to low level. In this case, the cleared state of the counter 82 is cancelled. In addition, when the clock is supplied at time t8, the output of the delay circuit 88 is inverted from high level to low level. In this case, the cleared state of the counter 90 is cancelled.

In the above-described configuration, the high gate counter 68 counts the number of times the reference clock either rises or falls only when the wobble signal resulting from being converted digitally into the pulse signal is at high level, as a result of which, when the number of the times reaches a predetermined value, it is judged that the wobble signal becomes high-level. Additionally, the low gate counter 72 counts the number of times the reference clock either rises or falls only when the wobble signal is at low level, as a result of which, when the number of the times reaches a predetermined value, it is judged that the wobble signal becomes low-level. In other words, the number of the times used for judging whether or not the wobble signal becomes high-level is not counted when the wobble signal is at low level, and the number of the times used for judging whether or not the wobble signal becomes low-level is not counted when the wobble signal is at high level.

Thus, according to the present embodiment, even when the wobble signal converted digitally into the pulse signal by the pulse signal generation circuit 60 includes noises so that counting of the number of times the reference clock either rises or falls is started by a first noise thereof, the counting can be prevented from being performed continuously thereafter. Therefore, it is possible to detect both a high-level period and a low-level period in the digitized wobble signal while alleviating influences of noises. Besides, at least the AND gate 62, the AND gate 66, the high gate counter 68, the low gate counter 72 and the RS flip-flop 70 form a chattering removing circuit that removes noises (chattering components) from the digitized wobble signal.

Additionally, in the above-described configuration, in a period after the cleared state of the counter 90 is cancelled until the counter 90 is latched, specifically, in a period after the wobble signal is judged to change from high level to low level until next time the wobble signal is judged to change from high level to low level, the number of times the wobble signal digitized by the pulse signal generation circuit 60 changes from low level to high level, i.e., the number of times edges of the wobble signal rise, is counted.

When the wobble signal is digitized appropriately according to the wobble 16 of the disk 12, noises are not superimposed on the wobble signal; therefore, the wobble signal rises once in one cycle. However, when the digitized wobble signal is influenced by noises, the wobble signal rises more than once, i.e., a plurality of times, in one cycle. As noises superimposed on the wobble signal become excessive, the number of times the wobble signal rises becomes larger, which means that the quality of the wobble signal converted digitally into the pulse signal by the pulse signal generation circuit 60 is aggravated. Accordingly, counting the number of times edges of the wobble signal converted into the pulse signal by the pulse signal generation circuit 60 rise in one cycle enables a judgment of the quality of the wobble signal.

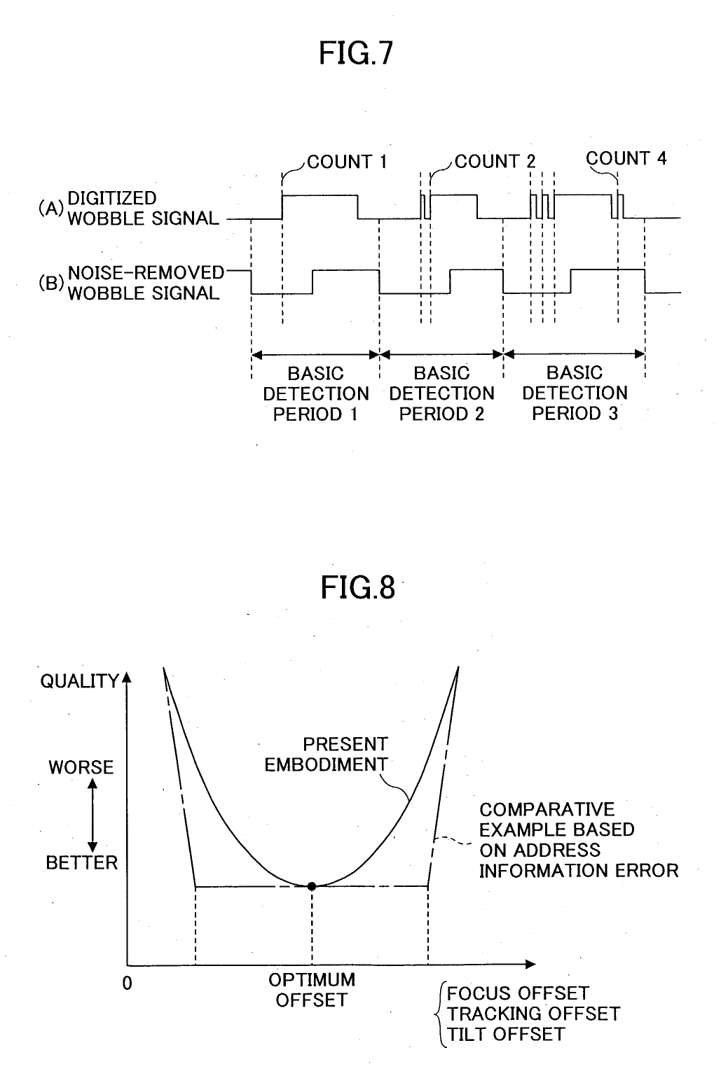

FIG. 7 is a diagram used for explaining a method for judging a quality of a wobble signal according to the present embodiment. FIG. 7 includes a case where the number of times edges of the wobble signal rise in one cycle is one (a basic detection period 1), a case where the number of the times is two (a basic detection period 2), and a case where the number of the times is four (a basic detection period 3).

In the present embodiment, the counter 90 outputs the number of times edges of the wobble signal in the form of pulses digitized by the pulse signal generation circuit 60 rise in one cycle. This output is supplied to the CPU 50. The CPU 50 judges the quality of the wobble signal according to the number of the times the edges of the wobble signal rise in one cycle thereof. Specifically, when the supplied number of the times is one, it is judged that the wobble signal is not deteriorated and the quality thereof is not aggravated. When the number of the times is more than one, i.e., a plurality of times, it is judged that noises are superimposed on the wobble signal and the quality thereof is aggravated. As the number of the times becomes larger, it is judged that noises superimposed on the wobble signal are greater and the quality thereof becomes more aggravated.

Besides, it may be arranged that the CPU 50 detects the number of times edges of the wobble signal rise in a plurality of cycles thereof, and judge the quality of the wobble signal according to the number of the times. That is, it may be arranged that a period including n basic detection periods (n representing a natural number), each of which is one cycle of the wobble signal, is predetermined as a detection period (={basic detection period} * n) for detecting the number of times edges of the wobble signal rise, and that the CPU 50 judges the quality of the wobble signal according to the number of the times the edges of the wobble signal rise in the detection period. In this case, too, when the number of the times exceeds a predetermined value, it can be judged that the quality of the wobble signal is aggravated; and as the number of the times becomes larger, it can be judged that the quality of the wobble signal becomes more aggravated.

Besides, it may be arranged that the CPU 50 detects the number of times edges of the wobble signal rise in each of the basic detection periods included in the detection period, and judges the quality of the wobble signal according to a maximum number of times among the detected number of the times. In addition, it may be arranged that a tolerance range is provided for the number of times edges of the wobble signal rise in each of the basic detection periods, and that the CPU 50 judges that the quality of the wobble signal is not aggravated when the number of the times is within three, for example, and judges that a quality abnormality occurs in the wobble signal when the number of the times exceeds three.

Thus, according to the present embodiment, the number of times edges of the wobble signal in the form of pulses generated by the pulse signal generation circuit 60 rise, which number corresponds to the quality of the wobble signal, can be output from the counter 90, and the quality of the wobble signal can be judged finely by degrees according to the number of the times.

FIG. 8 is a graph comparing the following cases 1 and 2: in the case 1, a quality of a wobble signal is judged by using the method according to the present embodiment; in the case 2, a quality of a wobble signal is judged by using a method of judging according to whether or not there occurs a detection error of address information which should be extracted according to the wobble signal (hereinafter the method used in the case 2 is referred to as comparative example). In FIG. 8, the case 1 according to the present embodiment is represented by a solid line, and the case 2 according to the comparative example is represented by a dashed line, in which the axis of abscissas indicates a focus offset, a tracking offset or a tilt offset of the optical system 24, and the axis of ordinates indicates the quality of the wobble signal to be judged.

As represented by the dashed line in FIG. 8, the detection error of the address information which should be extracted according to the wobble signal does not occur unless the focus offset, the tracking offset and the tilt offset become considerably different from an optimum offset. In other words, when these offsets approximate the optimum offset, the detection error of the address information does not occur. Thus, according to the method of the comparative example of judging the quality of the wobble signal according to whether or not the detection error of the address information exists, it is impossible to judge the quality of the wobble signal finely and precisely.

By contrast, in the present embodiment, the quality of the wobble signal is judged regardless of whether or not there occurs the detection error of the address information which should be extracted according to the wobble signal. As represented by the solid line in FIG. 8, as the focus offset, the tracking offset and the tilt offset differ from the optimum offset, the quality of the wobble signal becomes aggravated accordingly. Thus, according to the method of the present embodiment, the quality of the wobble signal can be judged before the detection error of the address information occurs, and the quality of the wobble signal can be judged finely and precisely.

Besides, in the present embodiment, it may be arranged that the CPU 50 drives the alarm speaker 52 and the warning lamp 54 when the number of times edges of the wobble signal in the form of pulses digitized by the pulse signal generation circuit 60 rise in one cycle exceeds a predetermined number of times (e.g., three times). According to this arrangement, a user can be informed that an abnormality occurs in the wobble signal generated in the optical disk device 10.

Additionally, it may be arranged that, when the number of times edges of the wobble signal in the form of pulses digitized by the pulse signal generation circuit 60 rise in one cycle exceeds a predetermined number of times (e.g., twice), the CPU 50 performs respective controls so that the focus offset, the tracking offset or the tilt offset approximates the optimum offset. According to this arrangement, the quality of the wobble signal can be optimized.

Besides, in the present embodiment, the number of times edges of the wobble signal converted into the pulse signal rise in one cycle is counted; however, it can be arranged that the number of times edges of the wobble signal fall be counted.

In Addition, the pulse signal generation circuit 60 according to the present embodiment comprises the integration circuit 60a connected to one of the input terminals of the comparator 60b; however, the pulse signal generation circuit may be composed of a direct-current removal high-pass filter and the comparator.

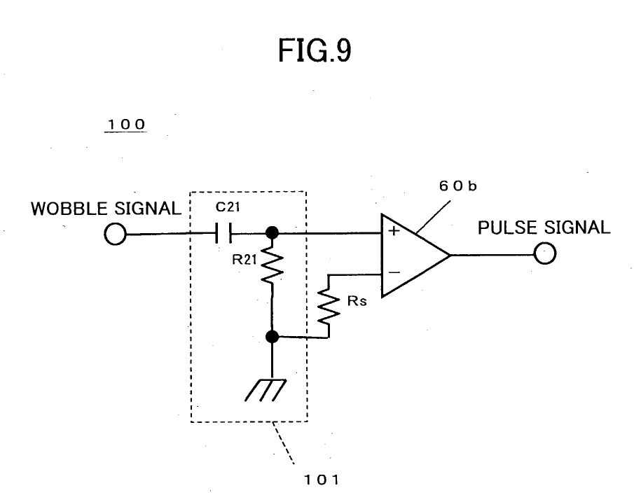

FIG. 9 is a block diagram showing a configuration of a variation of the pulse signal generation circuit 60. Elements in FIG. 9 that are identical to the elements shown in FIG. 4 are referenced by the same reference marks, and will not be described in detail.

A pulse signal generation circuit 100 according to the present variation comprises a direct-current removal high-pass filter 101, a resistance Rs and the comparator 60b.

The wobble signal is supplied to the direct-current removal high-pass filter 101. The direct-current removal high-pass filter 101 comprises a capacitor C21 and a resistance R21, and removes a direct-current component from the wobble signal. The wobble signal rid of the direct-current component by the direct-current removal high-pass filter 101 is supplied to the noninverting input terminal of the comparator 60b.

Additionally, the inverting input terminal of the comparator 60b is connected to a ground potential via the resistance Rs. The inverting input terminal of the comparator 60b becomes substantially zero potential due to the resistance Rs. The comparator 60b outputs a pulse signal that becomes high-level when the wobble signal assumes a positive polarity and becomes low-level when the wobble signal assumes a negative polarity. Thereby, the wobble signal as shown in FIG. 6-(A) is obtained.

In this course, since the input wobble signal (the input analog signal) passes through the direct-current removal high-pass filter 101, the chattering component is not removed; thus, the chattering component included therein is together digitized.

Besides, configurations of the pulse signal generation circuit are not limited to the circuit configurations shown in FIG. 4 and FIG. 9, and may be other configurations capable of digitizing the input analog signal together with the chattering component included therein.

The present invention is not limited to the specifically disclosed embodiments, and variations and modifications may be made without departing from the scope of the present invention.

The present application is based on Japanese priority application No. 2002-144478 filed on May 20, 2002, the entire contents of which are hereby incorporated by reference.

What is claimed is:

1. A signal processing circuit performing a signal processing according to a signal rid of a chattering component, the circuit comprising:
a digitizing circuit digitizing an input analog signal together with the chattering component included therein according to a level of said input analog signal; and
a chattering removing circuit removing the chattering component from the signal digitized by said digitizing circuit.

2. The signal processing circuit as claimed in claim 1, wherein said digitizing circuit includes:
an integration circuit outputting an average level of said input analog signal; and
an open-loop comparator performing a comparison of said input analog signal with said average level so as to output a signal corresponding to a result of said comparison.

3. The signal processing circuit as claimed in claim 1, wherein said digitizing circuit includes:
a high-pass filter removing a direct-current component from said input analog signal; and
an open-loop comparator performing a comparison of the input analog signal rid of said direct-current component with a zero level so as to output a signal corresponding to a result of said comparison.
